(19) United States
(12) Patent Application Publication
(10) Pub. No.: US 2024/0175289 A1
(43) Pub. Date: May 30, 2024

(54) Rabbit fence panel system

(71) Applicant: Jean-Marc Edouard Albert Gruneberg, Fitchburg, WI (US)

(72) Inventor: Jean-Marc Edouard Albert Gruneberg, Fitchburg, WI (US)

(21) Appl. No.: 17/952,427

(22) Filed: Sep. 26, 2022

(51) Int. Cl. E04H 17/22; A01M 29/30; E04H 17/16

(52) U.S. Cl. CPC E04H 17/22; A01M 29/30; E04H 17/16

(57) ABSTRACT

The invention pertains to a fencing system that provides correct spacing between each fence panel and prevents misalignment between the metal anchor rods and the vertical part of the panel frame.

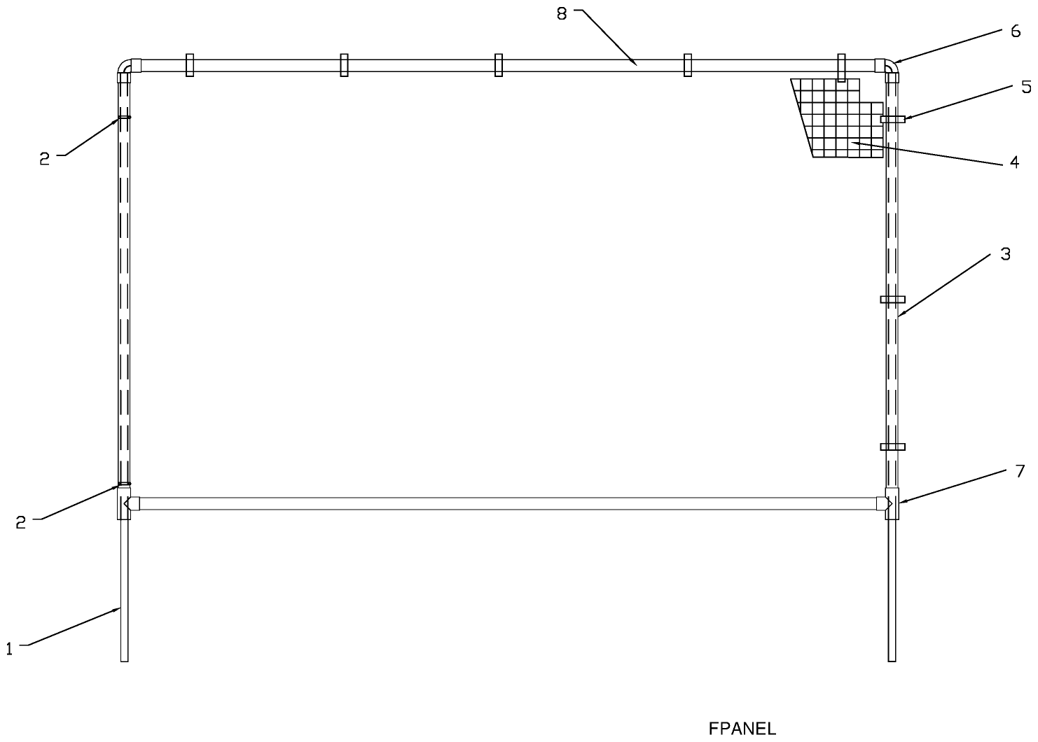

Panels can be installed without tools.

If there is sufficient room between vegetation and fence panel, then a simple gate is provided.

This gate is a fence panel that swings on 1 metal anchor rod.

Engaging the other vertical part of the panel frame with a short metal anchor rod will hold the gate closed.

It also allows vertical lift-up and off of the panel without tools from the metal anchor rods where there is no room between the vegetation and the fence.

The panel can be reinstalled without tools by inserting the vertical part of the panel frame over the metal anchor rod, this ensures correct spacing between each panel and prevents misalignment between the metal anchor rod and the vertical part of the panel frame.

### BACKGROUND

This invention is in the field of garden enclosures.

Traditionally chicken wire or plastic mesh is used with posts to produce an enclosure around gardens to prevent damage to the garden from pests such as rabbits. This invention provides pre-assembled panels which can be used to provide an enclosure. This invention is more flexible, more aesthetic, and can be installed without tools.

### SUMMARY OF INVENTION

This invention pertains to a fencing system that provides correct spacing between each fence panel and prevents misalignment between the metal anchor rods and the vertical part of the panel frame.

Panels can be installed without tools.

If there is sufficient room between vegetation and fence panel, then a simple gate is provided.

This gate is a fence panel that swings on one metal anchor rod.

Engaging the other vertical part of the panel frame with a short metal anchor rod will hold the gate closed.

It allows the vertical lift-up and off of a fence panel, without tools, from the metal anchor rod to provide easy access to the vegetation, where there is no room between the vegetation and the fence panel.

The fence panel can then be easily reinstalled. A drawing “FPANEL” is provided for reference and shows the construction of each fence panel as well as the metal anchor rods to support the panels.

A detailed description:

For each panel there are two metal anchor rods 1.

Each metal anchor rod is equipped with two O-rings 2.

The metal anchor rods 1 with the two O-rings 2 will be inserted into the vertical part of the panel frame 3.

The 90 degrees elbows 6 connecting the vertical panel Part of the frame 3 with the horizontal part of the panel frame 8

The tee's 7 connecting the vertical panel part of the frame 3 with the horizontal part of the frame 8 and creating an opening for the metal anchor rods 1 on the bottom the fence panel.

A mesh material 4 is stretched in the panel frame and held by a series of stainless-steel zip ties 5.

The metal anchor rod 1 will be restrained by the 90-degree elbow 6 at the top of the panel frame.

The O-ring 2 friction will keep the metal anchor rod 1 from falling out of the vertical part of the panel frame 3.

The two metal anchor rods 1 inserted into the vertical part of the panel frame 3 will ensure correct spacing between each panel, and prevent misalignment between the metal anchor rod and the vertical part of the panel frame 3

Panel can be installed by hand while pushing down on top of the 90-degree elbows 6.

The friction of the o rings 2 will allow installation of the panel without tools and ensures correct spacing between each panel, preventing misalignment between the metal anchor rod 1 and the vertical part of the panel frame 3.

If there is sufficient room between vegetation and fence panel, then a simple gate is provided.

This gate is a fence panel that swings on 1 metal anchor rod.

Engaging the other vertical part of the panel frame with a short metal anchor rod will hold the gate closed.

This invention allows the vertical lift-up and off of a fence panel, without tools, from the metal anchor rod to provide easy access to the vegetation, where there is no room between the vegetation and the fence panel.

The panel can then be reinstalled by inserting the vertical part of the panel frame 3 over the metal anchor rod 1. This is done without tools and ensures correct spacing between each panel and prevents misalignment between the metal anchor rod 1 and the vertical part of the panel frame 3.

I claim:

1. Providing a rabbit fence panel system which can be installed without tools, for vegetable and flower gardens, each panel comprising of:
a. two metal anchor rods equipped with two O-rings,
b. the fence panel frame consists of two horizontal and two vertical parts of the panel frame,
c. two elbows and two tees are connecting the horizontal and the vertical parts of the panel frame,
d. the tee provides an opening into the vertical tubing's at the lower intersection of the horizontal and vertical parts of the frame,
e. a mesh material,
f. series of stainless-steel zip ties,
g. the metal anchor rods with the two O-rings will be inserted into the vertical part of the panel frame and will be restrained by the start of the 90-degree elbow at the top of the panel frames,
h. the friction of the o rings will keep the metal rods from falling out of the vertical part of the panel frame,
i. pushing down by hand on the 90-degree elbow will move the metal rod extension into the ground,
j. this allows installation of the panel without tools,
k. and ensure correct spacing between each panel,
l. and preventing misalignment between the metal anchor rod and the vertical part of the panel frames,
m. and allows vertical lift-up and off of the panel, without tools, from the metal rods to provide easy access to the vegetation, where there's no room between the vegetation and the fence,
n. the panel can be reinstalled without tools by inserting the vertical part of the panel frame over the metal anchor rod and ensures correct spacing between each panel and prevents misalignment between the metal anchor rod and the vertical part of the panel frame.

2. The rabbit fence panel system according to claim 1 and claim 2 allowing the vertical lift-up and off of the panel from the metal anchor rods, as well as the reinstallation of the panel onto the metal anchor rods.
